(19) United States
(12) Patent Application Publication
(10) Pub. No.: US 2011/0283637 A1
(43) Pub. Date: Nov. 24, 2011

(54) WIND ABATEMENT DEVICE

(76) Inventors: BRUCE BUTLER, Houston, TX (US); Joshua Butler, Austin, TX (US)

(21) Appl. No.: 12/785,619

(22) Filed: May 24, 2010

(51) Int. Cl. E06B 3/30; E06B 3/26; E04H 9/14; E06B 9/02

(52) U.S. Cl. 52/202; 160/213; 52/741.3

(57) ABSTRACT

An abatement or protective device (10) is provided for protecting the opening in a structure, such as a window opening, during high winds. The device includes elongate generally vertical slats (22) and elongate generally horizontal slats (24) which are intertwined to form a panel. The device may include one or more panels. Various techniques are available for attaching the device to the structure surrounding the opening before anticipated high winds.

### FIELD OF THE INVENTION

The present inventions relates to devices which protect openings in a structure that are prone to damage during high winds or storms. More particularly, the invention is related to a versatile assembly which may be applied over the structure opening to reliably protect the structure and opening.

### BACKGROUND OF THE INVENTION

Various types of devices have been devised to protect a structure opening, such as a window or a doorway, from high winds, e.g., those that are commonly associated with a cyclone or a hurricane. The objective of the device is to first protect the integrity of the window or door. If that objective fails and a window panel breaks, the second objective is to severely limit the amount of wind, rain or debris that will enter the interior of the structure.

A wind abatement structure of this type may be generally classified as including either a solid rigid panel or sheet (such as plywood or plastic), a plurality of louvers (which are frequently referred to as storm shutters), and woven cloth or fabric. The device of the first type is disclosed in U.S. Patent Application 2008/0313979 A1. Devices with louvers are disclosed in U.S. Patent Applications 2008/0173410 A1 and 2008/0236766 A1. The woven cloth or mesh systems are disclosed in U.S. Pat. Nos. 6,327,085 6,176,050, and 6,865,852, as well as U.S. Publication 2008/0127598.

Prior art devices for protecting openings are generally expensive, difficult to attach, or provide limited protection. Many devices are difficult to install, especially during a typical storm warning due to their weight, size and attachment devices. Plywood, metal sheeting and other devices are bulky and difficult to store when not in use. Louvers are both expensive and limit the visibility from the window during normal use.

The disadvantages of the prior art are overcome by the present invention, and an improved wind abatement assembly is hereinafter disclosed.

### SUMMARY OF THE INVENTION

In one embodiment, a protection device for protecting an opening in a structure during high winds comprises a frame for attaching to opposing sides of the opening in the structure. The protection device includes a plurality of substantially horizontal slats each extending across a width of the frame, with each horizontal slat preferably being a unitary slat. Also provided are a plurality of substantially vertical slats most of which are interwoven between the plurality of horizontal slats. The protection device may be a rectangular meshed panel slightly larger than the opening, or may include two sliding panels or two panels connected by a hinge.

Further features and advantages of the present invention will become apparent from the following detailed description, wherein reference is made to the figures in the accompanying drawings.

### BRIEF DESCRIPTION OF THE DRAWINGS

FIG. 1 is a pictorial view of the abatement or protection detection device including two sliding panels, with each panel including interwoven slats.

FIG. 2 is a front view of the protection device shown in FIG. 1.

FIG. 3 is a top view of the protection device shown in FIG. 1.

FIG. 4 is an enlarged view of a reinforcing slat interwoven into a panel.

FIG. 5 is a pictorial view of a suitable slat.

FIG. 6 is a pictorial view of a protection device including two panels connected by a hinge, such that the top panel may thus be swung upward and secured to the structure adjacent the top of the opening to complete the mounting.

FIG. 7 is a front view of the panel shown in FIG. 6.

FIG. 8 is a side view of the FIG. 6 panel in a storage position.

FIG. 9 is a pictorial view of a reinforcing slat within the interwoven slats.

FIG. 10 is an enlarged view illustrating an upper portion of the reinforcing slat.

FIG. 11 is a cross-sectional view of an upper portion of the reinforcing slat shown in FIG. 9.

FIG. 12 is a front view of a protective device having a single panel.

FIG. 13 is a front view of the protection device shown in FIG. 6 having integrated, slideable horizontal slats also providing assembly reinforcement and mounting means.

FIG. 14 is a front view showing two independent protection panels configured for sliding vertically by interwoven slideable and reinforcing slats.

### DETAILED DESCRIPTION OF PREFERRED EMBODIMENTS

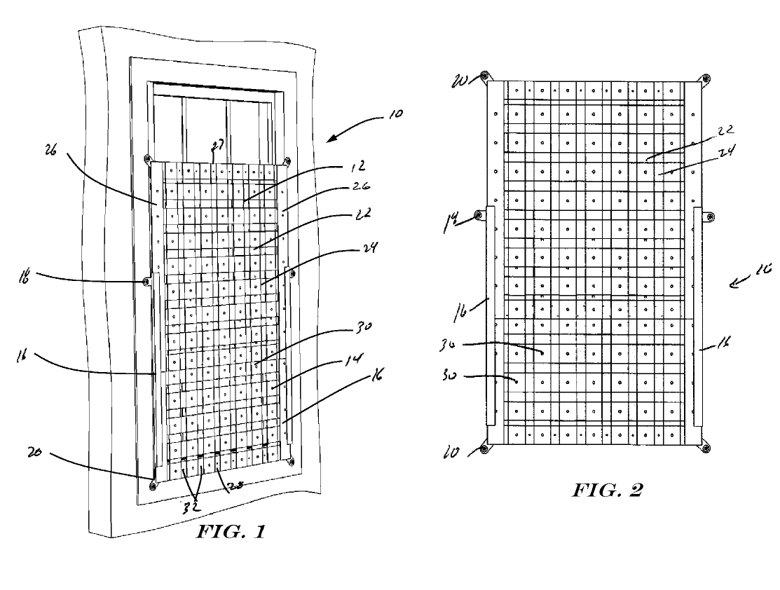

Referring now to FIG. 1, an abatement or protection device 10 for a window opening in a structure is shown. The device 10 as shown in FIG. 1 includes an upper panel 12 and lower panel 14, with the upper panel being vertically slidable with respect to the lower panel. Each panel may be fitted within a u-shape frame 16 provided on opposing sides of the window, with extension tabs and fasteners 18 securing the frame to the sides of the window. The upper panel 12 as shown in FIG. 1 is not yet raised to the upper-most position, and thus a portion of the window is still visible in FIG. 1.

Each panel 12, 14 in turn comprises a plurality of vertical slats 22 and interwoven horizontal slats 24. Each of the left side and right side slats 26 may be reinforcing slats, along with the top slat 27 and the bottom slat 28, to provide more rigidity to the panels. Reinforcing slats may be formed, for example, from metal, while the remaining slats may be formed from plastic. Panels may also be secured to the frame around the window with pivoting tabs 20 and conventional mounting screws. Interwoven slats as shown in FIG. 1 are connected by a single connector, such as rivet 30, which interconnects one of the horizontal slats or one of the vertical slats. Each of the upper and lower slats may include one or more holes or similar connectors for receiving a fastener to thereby secure the upper and lower panels directly to the window frame.

FIG. 2 is a front view of the panel as shown in FIG. 1 and more clearly depicts the laterally opposing members having channels 16 which may be secured to the building on each side of the window opening. For this embodiment, a single connection 30 is provided between a horizontal slat and a respective vertical slat, thereby allowing limited pivoting of the slats relative to each other.

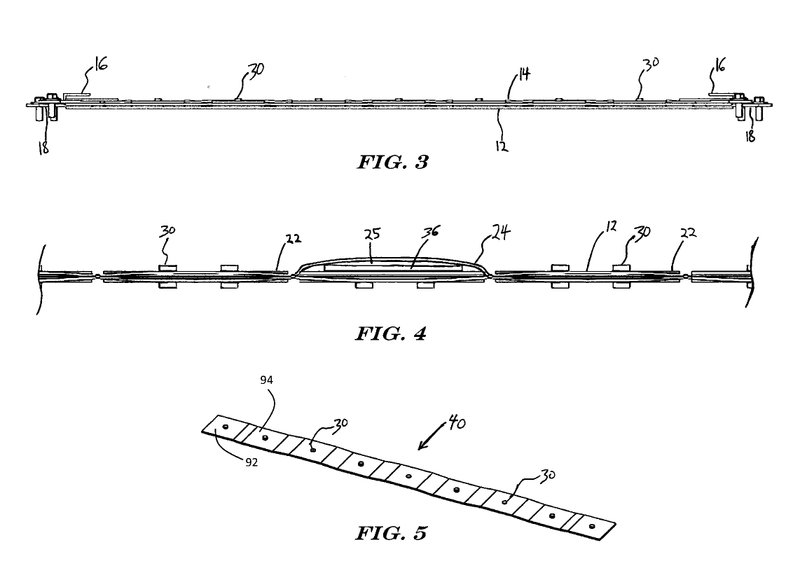

FIG. 3 is a top view of the device shown in FIG. 2, and illustrates more clearly the opposing u-shaped channel 16 to receive both the upper panel 12 and the lower panel 14. Similar connectors 30 are shown in FIG. 3.

FIG. 4 is an enlarged portion of a panel, and shows more clearly the horizontal slats 24 and the vertical slats 22. For this embodiment, the horizontal slat 24 is bent to form a large gap or slot 25 for receiving a reinforced vertical slat 36 which slides through this enlarged slot to provide reinforcement for the panel. The slat 36 may be interwoven between the horizontal slats in both the upper and lower panels once mounted to the structure. More than one such vertical reinforcing slat may be provided, and horizontal reinforcing slats may also be provided. A reinforcing slat has a bending stiffness greater than a conventional slat. A higher slat bending stiffness can be realized when the slat is thicker, wider, formed, or of a stronger material, for example.

FIG. 5 depicts a conventional slat which contains holes for rivets 30. The slat 40 may be bent slightly in a horizontal plane to form shallow valleys 92 and shallow hills 94, so that the corresponding vertical slat will fit snugly on top of a valley and under a corresponding hill. Each slat 40 is preferably a unitary, monolithic member, such as metal, plastic or a composite material, to reduce fabrication costs.

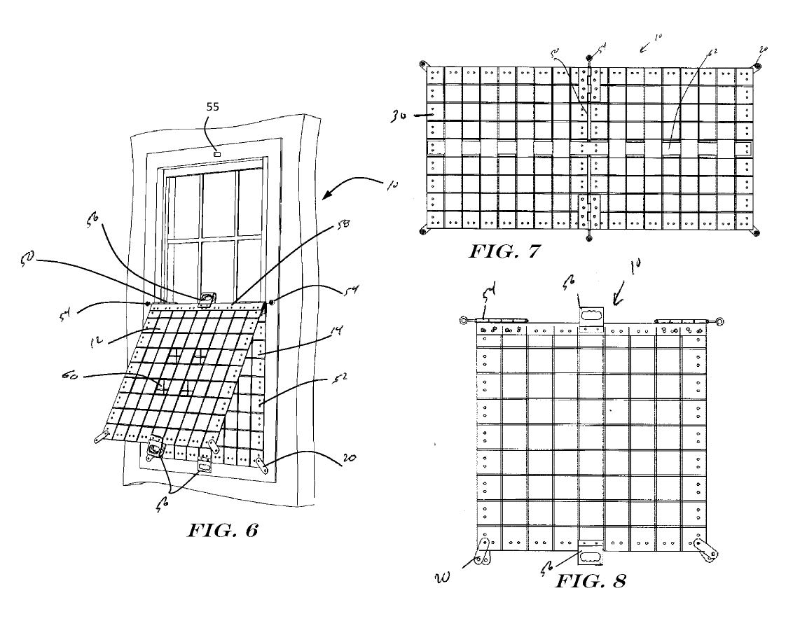

Referring now to FIG. 6, another embodiment of the device is shown, wherein panel 12 is connected to panel 14 by a hinge mechanism 50. Hinge mechanism 50 may comprise a long hinge extending across a width of the device, or shorter left side and right side hinges as shown in FIG. 6. The outer end of each hinge may receive an I-hook hinge pin 54, and a conventional screw or similar member may be used to secure the hinge and thus the panels to the structure. In this case, two or more fasteners such as rivets 52 are provided for interconnecting a vertical slat with a horizontal slat, although rivets are not provided along the length of each of the vertical and horizontal slats, and instead are only provided at the perimeter slats. Mounting tabs 20 are provided for securing each corner of the device to the window frame. An alternative hinge may be provided between panels by forming one or more lateral slats from a pliable material, such as silicone. If desired, vertical slats may terminate near the hinge, thereby allowing the upper and lower panels to bend about the hinge slats.

A handle 56 is connected to a central portion of the panels in the area of the hinge 50, and may be used for easily transporting the folded panels, e.g., when carrying the panels up a ladder. The handle can be constructed of flexible material such as silicone rubber that acts to absorb movement or deflection of the center of the installed panel against the protected window. The folded panels also have a reduced size for storage. For this embodiment, each of the two mounting slats or reinforcing slats 58 that are substantially parallel to an adjacent hinge 50 may be formed from metal or otherwise preferably reinforced. FIG. 6 shows two translucent horizontal slats and two translucent vertical slats in each panel forming translucent blocks 60 where these slats overlap. The handle 56 may also be attached to either end of the panel such that a structural protrusion such as a bolt 55 may be used to mount the folded or unfolded panel.

FIG. 7 illustrates the pivoting pin 50 as shown in FIG. 6, and further illustrates a vertical slat 62 formed from a reinforced material and extending between the top of the upper panel to the bottom of the lower panel. The upper and lower ends of the slat 62 may be secured to the upper and lower horizontal slats of each panel by rivets 30.

FIG. 8 illustrates the panel shown in FIG. 6 in the folded position for storage. The storage space is approximately one-half the area protected by the device when employed. Handle 56 may also be used for hanging the device in the storage area.

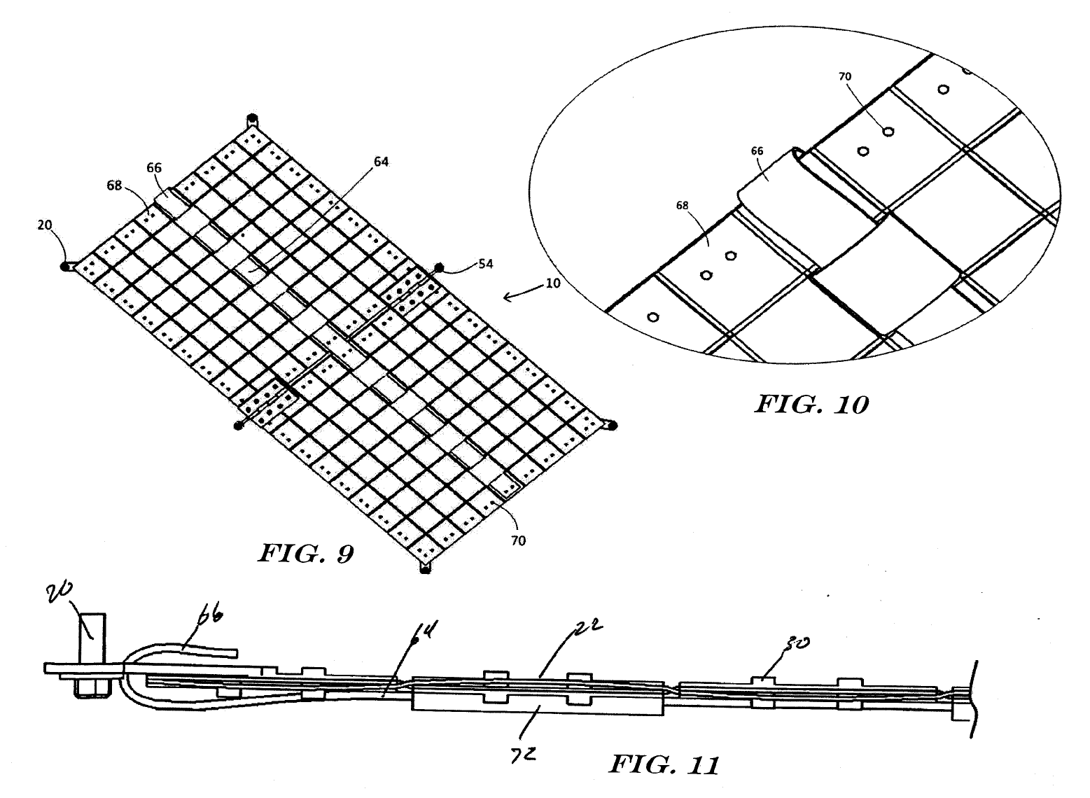

FIG. 9 illustrates a folding device similar to that shown in FIG. 6, except in this case a reinforced vertical slat 64 is used instead of reinforcing slat 62 as shown in FIG. 6. The upper end of the slat 64 includes a hook 66 which functions as a stop, such that the entire slat may be pressed downward between the horizontal slats once the panels are secured to the sides of the opening. The hook 66 is thus placed over the uppermost horizontal slat 68, and the slat 64 has a length so that the lower portion of the reinforcing slat will extend to the lowermost horizontal slat 70. The lowermost end of slat 64 may or may not be connected to the lowermost horizontal slat with rivets. The slat 64 not only provides reinforcement to the other slats, but also reinforces the substantially planar operating configuration of the upper and lower panels.

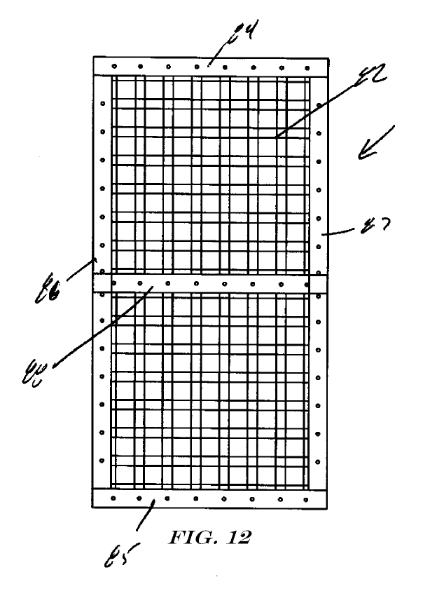

FIG. 10 illustrates further details with respect to the upper portion 66 of strap 64. FIG. 11 illustrates in greater detail the reinforcing slat 64 with the hook 66.

FIG. 12 depicts yet another version of a protective device according to the present invention. In this case, the device comprises a single panel 82 with horizontal slats and vertical slats as discussed above. The perimeter portions of the panel, namely the uppermost panel 84, the lowermost panel 85, the left side edge panel 86, and the right side edge panel 87 are each formed from a reinforcing material having a bending stiffness greater than the other panels. FIG. 12 also depicts a reinforcing slat 88 substantially midway between the top slat 84 and the bottom 85, and extending between the left side slat 86 and the right side slat 87. These reinforcing slats thus provide the frame for the device. This panel may be easily installed using conventional securing devices, including the protruding tabs that can pivot about a central axis integrated with a slat rivet.

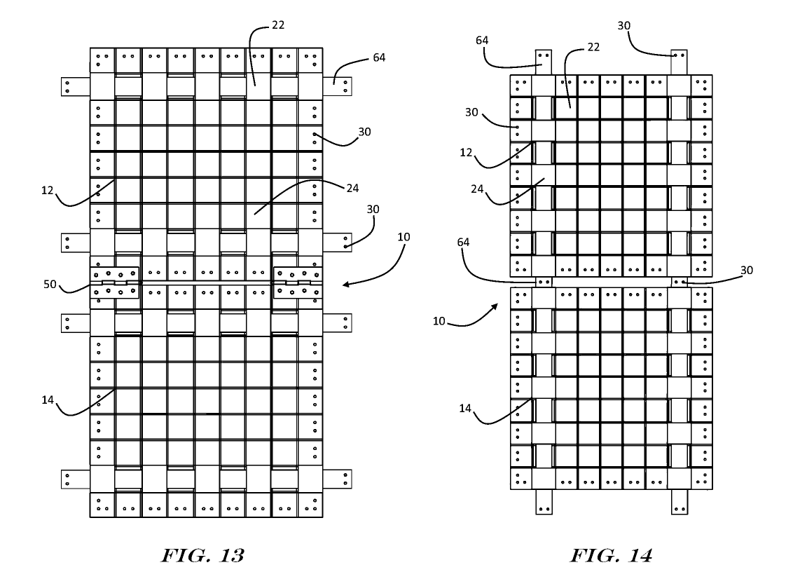

Referring now to FIG. 13, reinforcing slats 64 are shown providing support and reinforcement for panel assembly 10 connected with hinge mechanisms 50. Slats 64 are received by vertical slats 22 and outside all interwoven slats the 64 slats are affixed to the window frame with fasteners 70. The panel assembly 10 is slideable in the horizontal direction whereby slats 64 are preferably at least partially secured and thus are fixed in the horizontal direction. It is preferable for assembly 10 to slide left and right in this embodiment allowing the assembly position to be adjustable for a given window frame. Slats 64 may be received by vertical slats 22 adjacent a horizontal slat 24 such that the placement of slats 64 can be modified by removing and reinserting slat 64 at a different vertical height.

FIG. 14 shows another version of a panel assembly 10 with reinforcing slats 64 received now by horizontals slats 24. Further, panels 12 and 14 are not connected and therefore the position of each panel 12 and 14 is adjustable similar to the FIG. 13 panel, but independent of each other. The advantage of the FIG. 14 protection device is that slats 64 may be of any length greater than a panel 12 or 14 and panels 12 and 14 may be of varying overall dimensions or quantity such that for example a window frame twice the height of the assembly shown can be protected using one or more of the additional panels 12 and 14 and longer or paired 64 slats. Often, window frames are divided into subframes and the FIG. 14 embodiment is preferably whereby each panel 12 or 14 may protect individual window units within a window-sub-frame. Further, fasteners 30 are shown between panels 12 and 14 illustrating the option of integrating stops to constrain independent movement of panels 12 and 14 or also to secure the assembly to a middle region of a window frame or window sub-frame.

The use of interwoven vertical and horizontal slats to form a panel has significant advantages compared to solid sheet, louver, accordion, or roll-up designs. In the present case, should one slat fail, the device remains largely unaffected and may be replaced. Plastic sheets tend to fail by tearing. A tearing may occur in one of the slats, but the problem caused by a torn single sheet is significant compared to relatively minor problem if one of the slats is torn. Any combination of metal, plastic, or composite materials may be used for the slats. Damage prone areas or selected areas may be strengthened by using metal slats or slats formed from a thicker material, or slats that have integrated reinforcing strands or fibers. Each of the top and bottom, left and right slats of each panel may be made from metal or another more sturdy slat to increase strength while reducing the overall amount of required metal or reinforced slat. Reinforcement can optionally be achieved by attaching or interweaving reinforcement members between the slats. Additional mounts may be added with integrated tabs. Tabs may be fixedly secured to or allowed to pivot relative to the connected slat so that the tab may pivot about a central axis integrated with a slat rivet. In one embodiment, the horizontal and vertical edge slats are extended beyond the normal rectangular frame dimensions to facilitate attaching the extension and thus the device to the structure. Spaced gaps in the mesh design permit ventilation or reduce the large pressure differential between the window region and the outside environment. Slats are preferably each unitary, although slats may be manufactured as a composite material.

By changing the width and thus the spacing between slats, various window sizes can be accommodated with negligible changes in the manufacturing assembly process. Slats preferably have a width of at least ¼ inch, and more commonly will have a width of between 1 and 8 inches to accommodate various window sizes. An increase in a number of slats means increased hardware and weight, and may compromise integrity by bending thinner slats. Too few slats reduce the structural independency advantage of the interwoven slats, and a limited number of slats may not fit all applications.

At least four fasteners or other attachment devices are preferably provided to mount the device over a window. Fasteners may consist of metal sleeves inserted into predrilled holes, allowing a bolt to be threaded into the sleeve. Depending on the exterior of the structure, other conventional screw-type fasteners may be used, or latches may be pivoted from an open position to a locked position once the panel is in place. Various other types of attachment devices may be used depending largely on the size of the opening and the material of the structure.

A handle may be used for carrying the folded device up a ladder and for ease of installation. A hinge may have protruding eye-bolts for mounting to the trim or frame of the window. Once the eye-bolts are fastened to the structure, the bottom panel may be secured in place, then the top panel swung upward and secured in place.

While slight gaps are likely inherent if slats as used, layer gaps permit visibility without significantly reducing strength and also relieve stress concentrations on the overlapping edges. Translucent slats may be used from a material such as Lexan™, although such use may be minimized to reduce cost while providing the visibility benefit. A single translucent slat sheet would increase light and visibility if a gap or spacing exists, and overlapping translucent slats increase visibility at the intersection of these slats.

The method of protecting an opening in a structure during high winds should be apparent from the foregoing description. The method includes providing a plurality of substantially horizontal slats and a plurality of substantially vertical slats, with each of the slats having a width of at least ¼ inch. At least some of the horizontal slats are interwoven with at least some of the vertical slats to form a panel, and the panel is attached to the structure to substantially cover the opening. In one embodiment, a panel frame is provided for securing the panel to the structure over the opening, and the frame may include two or more of the perimeter slats forming the panel.

The device of the present invention provides significant protection with a relatively low weight compared to plywood or metal panels. Available slat material does not degrade with exposure to water and salt spray, and is not prone to rot, tearing, or similar vulnerabilities. Slat material does not require painting for protection, is easy to work with, and does not require any specialized tools. The material is lightweight for making installation easy, and the device may be safely installed over a structure opening by one person. The folding design as disclosed herein also requires less space for panel storage.

The device is removable in that it normally would be installed before an anticipated storm or storm season, and would be removed when the likelihood of a storm or other high winds decreased.

Although specific embodiments of the invention have been described herein in some detail, this has been done solely for the purposes of explaining the various aspects of the invention, and is not intended to limit the scope of the invention as defined in the claims which follow. Those skilled in the art will understand that the embodiment shown and described is exemplary, and various other substitutions, alterations and modifications, including but not limited to those design alternatives specifically discussed herein, may be made in the practice of the invention without departing from its scope.

What is claimed is:

1. A protection device for protecting an opening in a structure during high winds, comprising:
a plurality of substantially horizontal slats each extending across a width of the opening, each slat having a width of at least ¼ inch;
a plurality of substantially vertical slats each having a width of at least ¼ inch and interwoven between the plurality of the horizontal slats; and
a plurality of attachment devices for attaching the device to the structure.

2. A protection device as defined in claim 1, further comprising:
a perimeter frame for receiving portions of first and second panels each including the plurality of substantial horizontal slats and the plurality of substantially vertical slats, such that each panel may be mounted to the structure.

3. A protection device as defined in claim 1, further comprising:
a perimeter frame including a pair of laterally opposing members each having an elongate channel for receiving first and second panels each including the plurality of substantially horizontal slats and the plurality of substantially vertical slats, such that one panel may be moved vertically relative to the other panel by sliding within the pair of elongate channels.

4. A protection device as defined in claim 1, further comprising:
a hinge pivotally connecting first and second panels each including a plurality of substantially horizontal slats and a plurality of substantially vertical slats.

5. A protection device as defined in claim 4, further comprising:
a handle adjacent to the hinge for manipulating the protection device in a folded configuration.

6. A protection device as defined in claim 4, wherein the hinge axis is substantially horizontal when the device is mounted to the structure, and the attachment devices are provided at the upper and lower corners of the device when mounted to the structure.

7. A protection device as defined in claim 1, wherein each of the substantially horizontal slats and each of the substantially vertical slats is a unitary slat.

8. A protection device as defined in claim 7, wherein one of the plurality of vertical slats pivotally connects to one of the plurality of horizontal slats.

9. A protection device as defined in claim 1, further comprising:
one or more of the substantially horizontal slats and the substantially vertical is a reinforcing slat having a bending stiffness greater than the other of the plurality of slats.

10. A protection device as defined in claim 1, wherein one or more of a plurality of substantially horizontal slats and the plurality of substantially vertical slats are translucent, thereby providing at least partial visibility through the protection device.

11. A protection device as defined in claim 1, wherein each horizontal slat has a substantially uniform width along a slat length, and a recessed portion in one or more of the horizontal slats has a reduced width to provide an opening between the slats.

12. A protection device for protecting an opening in a structure during high winds, comprising:
a frame for attaching to sides of the opening;
a plurality of substantially horizontal slats each extending across a width of the frame, each horizontal slat being a unitary slat; and
a plurality of substantially vertical slats each being a unitary slat and interwoven between the plurality of the horizontal slats.

13. A protection device as defined in claim 12, wherein the frame includes a pair of elongate channels for receiving first and second panels each including the plurality of substantial horizontal slats and the plurality of substantially vertical slats, such that one panel may be moved vertically relative to the other panel by sliding within the pair of elongate channels.

14. A protection device as defined in claim 12, wherein the frame includes a hinge pivotally connecting first and second panels each including a plurality of substantially horizontal slats and a plurality of substantially vertical slats.

15. A protection device as defined in claim 13, further comprising:
one or more reinforcing slats in a substantially horizontal or substantially vertical orientation, the reinforcing slats having a bending stiffness greater than the other of the plurality of slats.

16. A protection device as defined in claim 13, wherein one or more of a plurality of substantially horizontal slats and substantially vertical slats having valley or hill portions each forming an opening to receive a portion of another slat when the slats are interwoven.

17. A protection device for protecting an opening in a structure during high winds, comprising:
a frame for attaching to opposing sides of the opening;
a plurality of substantially horizontal slats each extending across a width of the frame, each slat being a unitary slat having a width of at least ¼ inch;
a plurality of substantially vertical slats each being a unitary slat and having a width of at least ¼ inch and interwoven between the plurality of the horizontal slats; and
a plurality of attachment devices for attaching the device to the structure.

18. A protection device as defined in claim 17, wherein the frame includes at least a left side vertical slat and a right side vertical slat.

19. A protection device as defined in claim 17, wherein one or more of a plurality of substantially horizontal slats and substantially vertical slats having valley or hill portions each forming an opening to receive a portion of another slat when the slats are interwoven.

20. A protection device as defined in claim 17, wherein a reinforcing slat includes a hook for fitting over an uppermost horizontal slat.

21. A method of protecting an opening in a structure during high winds, comprising:
providing a plurality of substantially horizontal slats each having a width of at least ¼ inch;
providing a plurality of substantially vertical slats each having a width of at least ¼ inch;
interweaving at least some of the horizontal slats with at least some of the vertical slats to form a panel; and
attaching the panel to the structure over the opening.

22. A method as defined in claim 21, further comprising:
forming a frame from two or more perimeter slats for attaching the panel to the structure.
